(19) United States
(12) Patent Application Publication
(10) Pub. No.: US 2007/0289016 A1
(43) Pub. Date: Dec. 13, 2007

(54) Bi-modular system and method for detecting and removing harmful files using signature scanning

(76) Inventor: Sanjay Pradhan, Pune (IN)

Correspondence Address: Sucheta Bhagat, 3855 Charlemagne drive, Hoffman Estates, IL, 60195, US

(21) Appl. No.: 11/452,092

(22) Filed: Jun. 13, 2006

(51) Int. Cl. G06F 11/00

(52) U.S. Cl. 726/23

(57) ABSTRACT

A bi-modular system for detecting and removing harmful files on a computer without obstructing other processes running on the computer. The method and system include an initial scanning module initiating a signature database by creating one signature for each file on a computer, and a subsequent scanning module that re-uses the signature database created by the initial scanning module.

### RELATED APPLICATIONS

none.

### REFERENCE TO COMPUTER PROGRAM LISTINGS SUBMITTED ON COMPACT DISK

None.

### BACKGROUND

In the world of heavy Internet traffic all computers need a protection from external unwanted harmful files. Typically all computers are periodically scanned to detect presence of harmful files. A wide variety of softwares for detecting harmful files are currently available in the market. Normally these softwares are run on a computer several times a week. The softwares not only take long time to run but also use a very high percentage of the CPU resources, such that no other processes can run on the computer in a meaningful way during the computer scan.

Many softwares employ signature scanning for detecting harmful files. Creating a signature of a file is generally the most time consuming module in the scanning process. In most of the conventional scanning systems, this module enumerates all files and folders to be scanned and then prepares a new signature of every file on the computer every time the computer is scanned. By far the algorithm creating signature uses a very high percentage of the CPU resources during the signature creation. This not only decelerates the response of the CPU to other processes running on that computer, but also makes it difficult for user to continue running other processes on the computer during the scanning process.

The softwares that are currently available in the market allow a user to detect harmful files on a computer. However, the conventional scanning softwares neither allow user to effectively run other processes on the computer during the scanning process nor reuse the previously stored file signatures for the subsequent scans of the computer.

Accordingly, there is a need for an improved system and method for scanning computers employing flexible allocation of the computer resources during the computer scanning.

### BRIEF SUMMARY

By way of introduction only, the present embodiments provide a bi-modular system and method for detecting and removing harmful files on a computer without obstructing other processes running on the computer. The bi-modular system includes an initial scanning module initiating a signature database by creating one signature for each file on a computer, and a subsequent scanning module that re-uses the signature database created by the initial scanning module during the later scans.

The foregoing discussion of the preferred embodiments has been provided only by way of introduction. Nothing in this section should be taken as a limitation of the claims, which define the scope of the invention.

### BRIEF DESCRIPTION OF THE DRAWINGS

FIG. 1 illustrates the block diagram of the modules involved in the harmful file detection and removal system;

FIG. 2 is a flowchart that illustrates the events occurring in the harmful file detection and removal system;

FIG. 3 illustrates the control flow of the reuse database module of the harmful file detection and removal system;

FIG. 4 is a state diagram of the signature management module of the harmful file detection and removal system.

### DETAILED DESCRIPTION OF THE PRESENTLY PREFERRED EMBODIMENTS

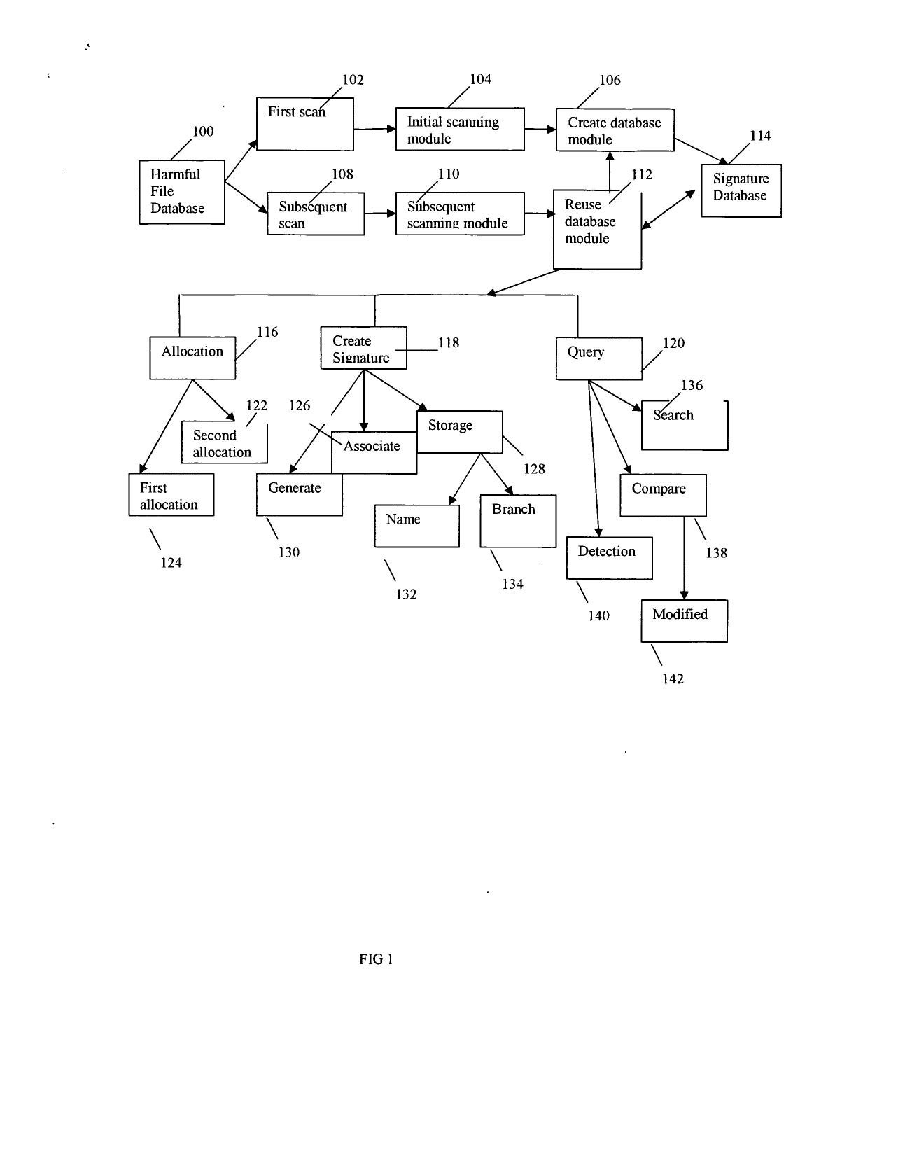

Referring now to the drawing, FIG. 1 illustrates the flow chart of the modules involved in the file detection and removal system (system). The system stores a database of harmful files in the harmful file database 100. The category of harmful files includes but is not limited to a virus, a spam ware, an ad (advertisement) ware, a mal ware, trojans, and other similar types of harmful files. When a user requests scanning of a computer for harmful files, the system determines whether this is the very first time the computer is being scanned or if the computer has been scanned before to detect the presence of the harmful files. The system makes this determination based on whether the signature database 114 is present at a predetermined location on the computer.

If the signature database 114 is found on the computer, the system determines that the computer has been scanned before and that the current scan is not the very first scan, but a subsequent scan 108 on the computer. Hence, the system invokes subsequent scanning module 110 that loads the signature database 114 in the memory and if possible, re-uses the signature database 114 via reuse database module 112.

On the other hand, if the signature database 114 is not found at a predetermined location on the computer, the system determines that the current scan is the very first scan of the computer. Then the system invokes an initial scanning module 104, which invokes create database module 106 to create the signature database 114 on the computer for the very first time. The create database module 106 populates the signature database 114 by creating one signature for each file on the computer. In one embodiment, the signature database 114 is located in the root directory of a file, but it could also be located elsewhere.

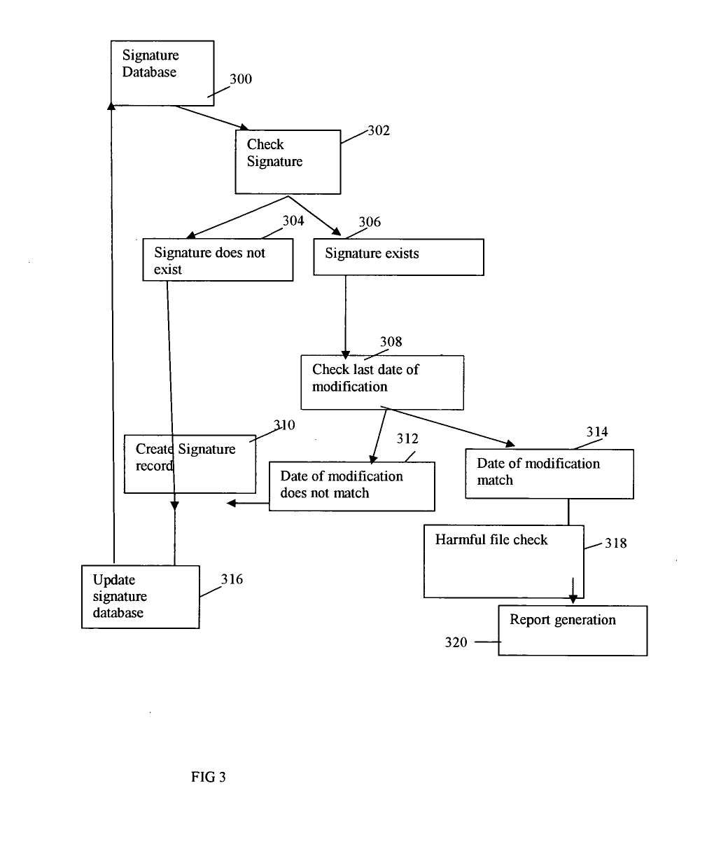

The subsequent scanning module 108 always enumerates all the files located on the computer. However, it does not create a new signature for the files whose signatures are already present in the signature database 114. In stead of creating a new signature for each file on the computer every time the computer is scanned for harmful files, if possible, the system reuses the signatures of the previously scanned files stored in the signature database 114. This reuse action, which is not apparent to the user, saves the valuable system resources. The control flow of the system's reuse database module 112 is further illustrated in FIG. 3.

The system maintains at least two databases, a harmful file database 100 containing at least one harmful file, and the signature database 114 containing the signatures of the files on the computer. The files in the harmful file database are provided by some external entity. The system consists of an allocation module 116 that designates a memory space for storing a database. The allocation module contains a sub-module called first allocation module 124 which allocates a first memory space for storing the harmful files database 100. The harmful file database 100 is populated even prior to the first scan 102 of the computer.

Yet another sub-module of the allocation module, a second allocation module 122 allocates a second memory space for storing a signature in the signature database 114. The signature database is searched for the given file signature, if the given file signature is not found in the signature database, the second allocation module 122 allocates the second memory space to store the given signature along with its other attributes in the signature database.

On the other hand, if the given file signature is found in the database, the attributes of the given file signature are compared with the searched file attributes. Having two files with identical signature and dissimilar attributes imply that the signature has been modified after it was stored in the signature database, and the change has not been updated in the signature database 114. Hence the second allocation module 122 allocates the second memory space either if the file signature does not exist in the signature database 114 or if the signature database 114 contains an out dated file signature.

Unlike the harmful file database 100, the signature database 114 is empty prior to the first scan 102. The system consists of a create signature module 118 for creating a unique file identifier (signature) for each file located on the computer. The create signature module 118 has three sub-modules, a generate module 130 that generates the signature, an associate module 126 that associates the signature with a file on the computer, and a storage module 128 that stores several file attributes in the signature database. If the given signature does not exist in the signature database all the three sub-modules together create a new record in the signature database. However, only the associate module 126 and the storage module 128 are used to update an existing entry in the signature database.

In a preferred embodiment of the present invention, the storage module 128 utilizes a dynamic linked list to store the data associated with the signature in the signature database 114. The storage module 128 stores attributes including but not limited to the size of the file, the date and the time of modification of the file. Since the signature database for each file is located in the root directory of the given file, it is important to store the relative location of the given file in the directory structure of the computer. Hence, the system stores the name of root directory of the given file.

The storage module 128 employs a name module 132 to store a name of the parent folder of the file, and a branch module 134 to store one signature database for each directory for which scanning is requested. For example if given file is called “data” and it is located at C:→documents→data→analysis, then name module will store string “documents”, and branch module will store “analysis”. Likewise the signature database for all the files in the directory “analysis”, “data”, “documents” will be located in the directory “C:”. It is possible that these databases will be identified as signature_database_documents, signature_database_data, signature_database_analysis etc. The number of signature databases in the root directory would be at least number of files and directories in that directory. This storage arrangement aids the system in organizing the information in the signature database 114.

The system has a query module 120 searching the signature database 114 for the given file signature. The query module utilizes a search module 136 that locates the file in the signature database whose signature is identical to the signature of the given file. Furthermore, the query module 120 employs a compare module 138 that compares several attributes of the file whose signature is identical to the signature of the given file with the several attributes of the given file. The attributes compared include but are not limited to the file size, the date and the time of file modification.

The compare module also has a modified module 142 that deletes the file record in signature database if any of the compared attributes of the two files do not match. If two files with the same signature display different attributes, for example, different date, time of modification, file size etc. it implies that the file has been changed after the file was stored in the signature database. The modified module 142 deletes such out dated entry from the signature database 114. The create signature module 118 has a sub-module associate 126 to associate the given signature in the signature database with the modified given file attributes. It must be noted that no new signature is generated at this time and only associate 126 and storage 128 modules are invoked to update the signature database.

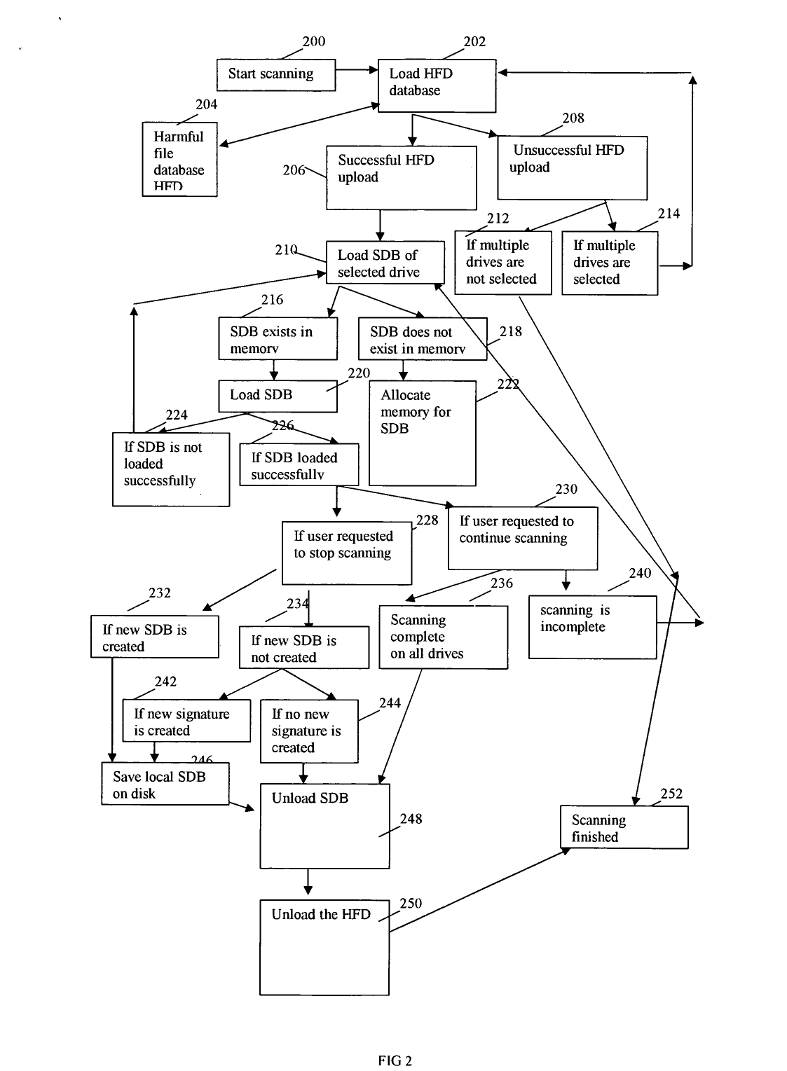

FIG. 2 is a block diagram of the events occurring in file detection system. A start scanning event 200 occurs when a user requests to scan a computer for presence of harmful files. Alternatively, the system can be configured as a continuous polling system where the computer is configured to be periodically scanned for harmful files without having the computer user explicitly request the computer scan. The system loads harmful file database 202 via a load harmful files database (HFD) 204 event. The harmful file database 204 contains the files that can be harmful for the computer.

Once the system verifies that the harmful file database is successfully loaded via successful database upload 206 event, the load signature database event 210 is raised. On the other hand, if the harmful file database upload is unsuccessful, the system raises unsuccessful database upload 208 event, and checks whether multiple drives are selected for scanning. If multiple drives are selected for scanning 214, then the harmful file database load 202 is attempted one more time. But, if the harmful file database is not successfully loaded, and if only one drive is selected for scanning 212 then the system raises the scanning finished event 252.

Subsequently the system checks whether the Signature Database (SDB) exists in the memory. If SDB does not exist in the memory 218, then memory is allocated for storing the SDB 222. According to one embodiment of the present invention, the SDB is stored in a dynamic linked list, therefore memory is allocated for the root node of a linked list. The reason the preferred embodiment employs the linked list is that a new node can easily be inserted in the linked list fostering dynamic data storage management. Alternatively, SDB can also be stored in any other data structure such as array, a stack, or a queue.

On the contrary, if SDB exists in the memory 216 then load SDB event 220 is invoked. If the SDB is not loaded successfully 224, then SDB load 210 is attempted one more time. But, if the system determines that the SDB is loaded successfully 226, the system checks whether the user has requested to stop scanning 228.

If the user has requested to stop scanning 228 then the system checks whether new SDB 232 is created. If the new SDB is created, it is saved on the local disk 246, and the system unloads the SDB by freeing the memory allocated for the SDB 248. Furthermore, the system also unloads the harmful file database by freeing the memory allocated for the harmful file database 250. However, if the new SDB is not created 234, the system checks if the new signature is created 242, and if the new signature is created, it is saved on disk 246. On the other hand, if the no new signature is created 244, SDB is unloaded by freeing up the memory allocated for SDB 248 and HFD is unloaded by freeing up the memory allocated for harmful file database 250.

But if the user has requested to continue scanning 230, then the system checks whether the scanning is complete on all drives 236. If the scanning is complete, then the system unloads SDB by freeing the memory allocated for SDB 248 and unloads harmful file database by freeing the memory allocated for harmful file database 250. In contrast, if the system determines that scanning is incomplete 240, then the system invokes load the SDB of the selected drive event 210 where next drive is scanned for presence of the harmful files. Lastly, once all the files on the computer are scanned the system checks whether the scanning is finished 252. Therefore, the SDB is updated only if the new signature database is created or when the new signature is created.

FIG. 3 illustrates the control flow of the system's reuse database module. First the signature database 300 is loaded in the memory. Then all of the files on the computer are scanned. In one embodiment of the present invention, the system processes only one file at a time, and continue to do so until each file on the computer is scanned. Alternatively, simultaneous scanning of several files on a computer can be performed in some other embodiment. The file currently being scanned is called a given file. A check signature module 302 first identifies a given file signature associated with the given file. The check signature module 302 then searches the signature database 300 to locate the file (identical file) whose signature is identical to the given file signature. The search may reveal that the given file signature does not exist 304 in the signature database 300. In that case the system invokes create signature record module 310 which creates a record in the signature database to store the attributes of the given file. The newly created signature is then uploaded in the signature database 300 via an update signature database module 316.

In one embodiment, the system uses MD5 algorithm to generate the signature. In the subsequent scanning module, when the computer is being scanned more than once, the process of maintaining the signature database on the computer saves the CPU time required to prepare the MD5 signature. The signature database search employs a memory function which makes it significantly faster than creating a new file signature every time the computer is scanned for harmful files.

Alternatively, the search may reveal that the given file signature exists 306 in the signature database 300. In that case, the system invokes a check last date of modification module 308. This module compares the last date of modification of the given file and the identical file. Then, the system invokes harmful file check module 318 if the date of modification of the given file matches with the date of modification of the identical file 314. Also, a similar module (not shown here) compares the time of last modification of the given file and the identical file; the system invokes harmful file check module 318 if the time of modification of the given file matches with the time of modification of the identical file. Finally, yet another similar module (also not shown here) compares the size of the given file and the identical file; the system invokes harmful file check module 318 if the size of the given file matches with the size of the identical file.

The harmful file check module 318 searches the harmful file database to check if the given file is in fact a harmful file. If the given file is a harmful file then, report generation module 320 generates a report which alerts the user of the presence of the harmful file on the computer. After generating report the system employs a removal module that removes harmful files from the computer. Likewise the entry for the harmful file is also deleted from the signature database.

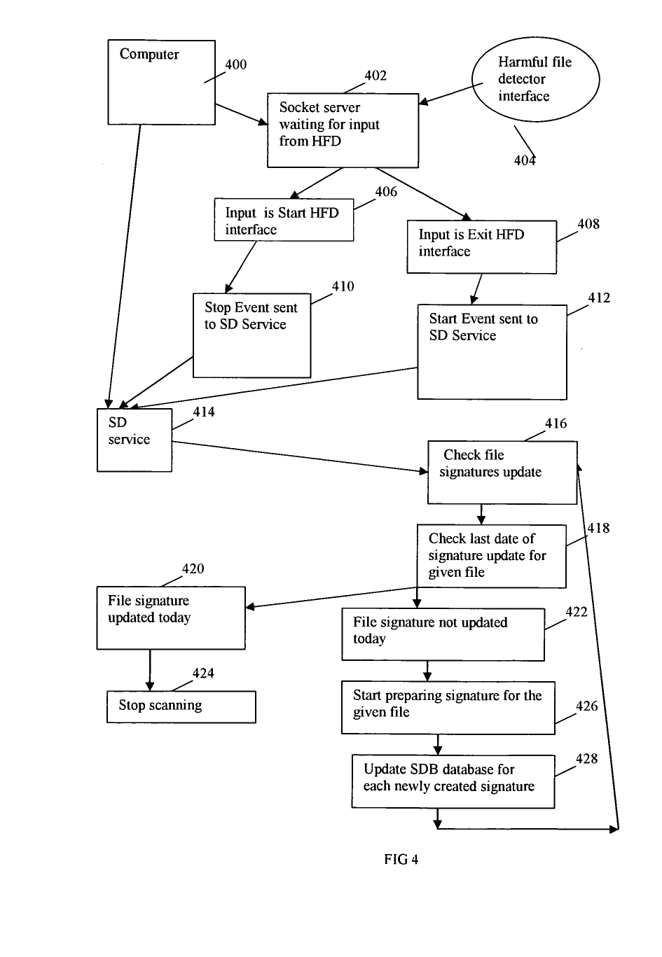

FIG. 4 is a block diagram of the signature management module of the system. Harmful File Detector interface HFD 404 is the main interface of the system according to one embodiment of the present invention. This interface uses a local signature database (not shown here) to accelerate the scanning process every time the computer is scanned for harmful files. The socket server 402 awaits input from the harmful file database interface.

A SD service 414 starts automatically as the computer 400 is boot up. SD Service is a NT service which runs in the background and prepares the signature database for all drives on the computer being scanned for the harmful files. Since this service runs in the background, it is ensured that preparation of the signature database for each directory utilizes a very low percentage of the available CPU and memory resources. The SD service 414 implements the system's unique feature of monitoring the CPU usage. The system checks the total CPU usage of the computer and the amount of CPU used by the SD Service 414.

Having the CPU used by SD Service 414 equal to the CPU usage of the computer, possibly denotes that the user is currently not using the computer and no other process running on the computer need CPU resources. In that case, the MD5 algorithm starts running at the top speed using a very high percentage of the CPU resources. For example the SD service utilizing close to 100% of the CPU resources prepares the signature for a 1.5 MB file in approximately 300 milliseconds.

In contrast, having computer's total CPU usage greater then the CPU used by the SD Service 414 implies that some other process on the computer requires the CPU resources. Then the MD5 algorithm uses a very low percentage of CPU resources allowing the other processes to use the computer at its maximum capability. For example the SD service utilizing uses a very low percentage of the CPU resources prepares the signature for a 1.5 MB file in approximately 30 seconds. Thus, the system uses a varied amount of the CPU resources wisely and prepares the signature as fast as possible depending on the state of the computer.

The SD Service 414 checks once a day if the signature databases of all the drives are update as of the date of current scan i.e. today's date 416. A registry entry is maintained on the computer indicating the last date of database update for each of the individual drives. The SD service either started or stopped depending upon the input from the HFD interface. If the input is to start harmful file database interface 406, the system sends a stop SD service event 410 to the SD Service 414. Then, the SD service 414 halts the scanning process and saves the signatures in the signature database. Similarly, if the input is to exit the harmful file database interface 408, a start event 412 is sent to the SD Service, the SD service 414 then resumes the previously halted task of preparing the signatures.

Once resumed, the SD service 414 checks whether signatures of all the drives on the computer are update as of the date on which the computer is being scanned i.e. today by raising a check file signature update event 416. This event identifies the last date when the signature of the given file was updated 418. This date is then compared to the date on which file is scanned i.e. today's date 418. If the signature was updated today 420, then the system stops scanning 424.

However if the signature is not updated today 422, but was updated sometime in the past and is out of date, the SD service 414 starts preparing the signature for the given file 426. Furthermore, the SD service updates the signature database by adding the newly created signature in the signature database of the drive the file is located in. Obviously, the registry entry is modified to indicate today's date as the last date of signature update for the given file.

From the foregoing, it can be seen that the present invention provides method and apparatus for assisting users to efficiently scan their computers via flexible resource allocation database search system. The present invention thrives to maximize the convenience of the computer user while minimizing the amount of CPU and memory resources used for a computer scan.

This is accomplished by adopting a method whereby once a database file is loaded into memory, the same memory location is converted into a link list avoiding the steps of first extracting database from the file and then building a link list. Because the data structure used to store the database is a link list, the time required to search the databases is also drastically reduced.

Furthermore since the file attribute information such as date time and size is stored for all the files, it is possible to reuse the signatures. The signatures of unmodified files are generally reused while signatures of only modified files and new files (i.e. files that are being scanned for the first time on the computer) are prepared during the scan. The reuse of the previously created file signature helps reduce CPU usage during the database update. This provides time savings to the user and allows the user to continue working on the computer while the computer is scanned for harmful files.

It would take about 30 minutes to complete a conventional scan on a Pentium 4 machine with 256 MB RAM and 40 GB hard disk with about 200,000 files and folders. In contrast, it would take about 2 minutes to complete the scan according to the present invention system on a Pentium 4 machine with 256 MB RAM and 40 GB hard disk with about 200,000 files and folder.

While a particular embodiment of the present invention has been shown and described, modifications may be made. It is therefore intended in the appended claims to cover such changes and modifications, which follow in the true spirit and scope of the invention.

We claim:

1. An file detection and removal system (system) for detecting and removing harmful files on a computer without obstructing other processes running on the computer, the system comprising:
an initial scanning module that initiates a signature database by creating one signature for each file on a computer, and
a subsequent scanning module that re-uses the signature database created by the initial scanning module during the later scans, in stead of creating a new signature for each file on the computer every time the computer is being scanned for harmful files.

2. The system of claim 1 further comprises:
an allocation module that allocates a memory space for storing a database;
a create signature module that creates a unique file identifier (signature) for each file located on the computer, and
a query module that searches the signature database for the signature.

3. The system of claim 2 wherein the allocation means comprises:
a first allocation module that allocates a first memory space for storing a harmful files database, and
a second allocation module that allocates a second memory space for storing a signature database.

4. The system of claim 2 wherein the create signature means comprises:
generate module that generates the signature;
associate module that associates the signature with a file (first file) on the computer, and
storage module that stores a plurality of attributes of the first file in the second memory space.

5. The system of claim 4 wherein the storage module employs a dynamic linked list to store signature data in the signature database.

6. The system of claim 4 wherein storage module comprises:
name module that stores a name of the parent folder of the first file, and
branch module that stores one signature database for each directory for which scanning is requested.

7. The system of claim 4 wherein storage module stores the size, the date of modification, and the time of modification of the first file.

8. The system of claim 2 wherein the query means comprises:
a search module that locates the first file in the signature database such that the signature of the first file matches with the signature of a second file;
a compare module that compares the plurality of attributes associated with the first file and the second file;
a detection module that identifies presence of a harmful file on the computer, and
removal module that removes harmful files from the computer.

9. The system of claim 2 wherein the compare module compares the date of modification of the first file and the second file.

10. The system of claim 9 wherein the compare module comprises a modified module that deletes the plurality of attributes associated with the first file if the date of modification of the first file does not match with the date of modification of the second file.

11. The system of claim 2 wherein the compare module compares the time of modification of the first file and the second file.

12. The system of claim 11 wherein the modified module deletes the plurality of attributes associated with the first file if the time of modification of the first file does not match with the time of modification of the second file.

13. The system of claim 2 wherein the compare module compares the size of the first file and the second file.

14. The system of claim 13 wherein the compare module further comprises a modified module that deletes the plurality of attributes associated with the first file if the size of the first file does not match with the size of the second file.

15. A system for comparing files without obstructing other computer processes, the system comprising:
a database to store a first predetermined attribute;
a compare module comparing the first predetermined attribute with a second predetermined attribute;
a determine module to decide if the first and the second attributes are identical, and
a monitoring system deciding the allocation of the computer resources.

16. A file comparison method for detecting harmful files on a computer without obstructing other processes running on the computer, the method comprising:
an initial scanning step storing a plurality of predetermined attribute to initiate a signature database;
a subsequent scanning step using the signature database created by the initial scanning step to compare a second attribute to the predetermined attribute;
determining if the predetermined attribute is identical to the second attribute, and
monitoring the CPU usage to determine allocation of resource.

17. The method of claim 16 comprises using the signature database created by the very first scan for each subsequent scan to avoid generating a new signature if the given file identifier is found in the signature database and if the signature attributes match with the file identifier attributes.

18. The method of claim 16 wherein the receiving step further comprises continuously polling the user computer for a file identifier of the modified files.

19. The method of claim 16 wherein the subsequent scanning step further comprises:
means for receiving a given file identifier associated with a file for which the scan is requested;
means for identifying a second attribute associated with the given file identifier (given file attributes);
means for querying the signature database for the given file identifier;
means for comparing the predetermined attributes with the given file attributes, if the given file is found in the signature database, and
means for generating a unique file identifier (signature), if the given file identifier is found in the signature database but at least one predetermined attributes does not match with the given file attribute.

20. The method of claim 19 wherein the subsequent scanning step further comprises:
means for storing the plurality of attributes associated with the newly generated signature in the signature database in the root directory of the directory for which the scan is requested, and
means for updating the plurality of attributes associated with the newly generated signature in a second memory space.
